(19) United States
(12) Patent Application Publication
(10) Pub. No.: US 2014/0008324 A1
(43) Pub. Date: Jan. 9, 2014

(54) METHOD FOR MAKING PLASTIC ARTICLES HAVING AN ANTIMICROBIAL SURFACE

(71) Applicants: Maria A. Appeaning, St. Paul, MN (US); Caroline M. Ylitalo, Stillwater, MN (US); Narina Y. Stepanova, Inver Grove Heights, MN (US); Moses M. David, Woodbury, MN (US)

(72) Inventors: Maria A. Appeaning, St. Paul, MN (US); Caroline M. Ylitalo, Stillwater, MN (US); Narina Y. Stepanova, Inver Grove Heights, MN (US); Moses M. David, Woodbury, MN (US)

(73) Assignee: 3M Innovative Properties Company, Saint Paul, MN (US)

(21) Appl. No.: 14/002,585

(22) PCT Filed: Mar. 27, 2012
(86) PCT No.: PCT/US12/30703

§ 371 Date: Aug. 30, 2013

Related U.S. Application Data
(60) Provisional application No. 61/470,321, filed on Mar. 31, 2011.

(51) Int. Cl. C08J 7/18

(52) U.S. Cl. CPC C08J 7/18
USPC 216/67

(57) ABSTRACT

Herein are disclosed methods for processing plastic substrate surfaces having inorganic antimicrobial microparticles within. The methods involve providing a plastic substrate having a substrate surface, having inorganic antimicrobial microparticles within the plastic substrate, and exposing the substrate surface to a plasma.

### BACKGROUND

1. Field of the Disclosure

The disclosure relates generally to methods for processing plastic substrates having inorganic antimicrobial microparticles within.

2. Brief Description of Related Technology

A great deal of attention has been paid in recent years to the hazards of bacterial contamination from potential everyday exposure. Microbial growth on surfaces can pose serious threats to human health. As such, manufacturers have begun incorporating antimicrobial agents within various household products and articles.

A number of inorganic materials have been shown to possess antimicrobial activity, include transition metals (e.g., silver, copper, zinc, gold, cerium, platinum, palladium, or tin). It is theorized that these metals, or ions thereof, exert their effects by disrupting respiration and electron transport systems upon absorption into bacterial or fungal cells.

Silver and salts thereof have been used as an antimicrobial agent for centuries, and with the development of nano-silver technology, the use of silver in inorganic nano-particle form has produced a platform of high performance antimicrobial agents. Generally, these nano-silver materials consist of silver ions integrated into inert matrices consisting of ceramic, glass, or zeolite. Inorganic, silver-based antimicrobials that allow for controlled silver ion release have been proven effective against a variety of pathogens in a variety of environments and have been incorporated in a number of different materials of potential use in healthcare.

It has been proposed that silver ions interact with disulfide or sulfhydryl groups of enzymes within cells causing structural changes that lead to disruption of metabolic processes followed by cell death. Eukaryotic cells (e.g., red blood cells and leukocytes) possess the necessary cellular mechanisms to overcome this disruption, whereas prokaryotic organisms (e.g., bacteria) do not, and hence silver can rapidly reduce or eliminate prokaryotic pathogens. Thus, silver-releasing particles provide an advantage over other antimicrobial agents that indiscriminately destroy both prokaryotic and eukaryotic cells.

### SUMMARY

In one aspect, the disclosure provides a method of making a plastic article having an antimicrobial surface, the method comprising providing a plastic substrate having a substrate surface, wherein the plastic substrate comprises inorganic antimicrobial microparticles disposed within; and plasma etching the substrate surface to expose a portion of the inorganic antimicrobial microparticles. In some embodiments, the inorganic antimicrobial microparticles comprise a ceramic carrier and at least one antimicrobial metal. In some embodiments, the ceramic carrier is at least one of clay, zeolite, or silicon dioxide. In some embodiments, the antimicrobial metal is a transition metal. In some embodiments, the at least one antimicrobial metal is selected from the group consisting of silver, gold, copper, and zinc.

In some embodiments of the method of the disclosure, the inorganic antimicrobial microparticles have an average particle size that is at least 1 micrometer. In some embodiments, the inorganic antimicrobial microparticles have an average particle size that is in a range of from 5 micrometers to 10 micrometers.

In some embodiments of the method of the disclosure, the inorganic antimicrobial microparticles have an average particle size that is at least an order of magnitude smaller than a smallest dimension of the plastic substrate.

In some embodiments, the inorganic antimicrobial microparticles are stable to processing at temperatures up to 1000° C. (in some embodiments, up to 900° C., up to 800° C., up to 700° C., up to 600° C., or even up to 500° C.).

In some embodiments, the substrate surface comprises at least 0.1% by area (in some embodiments, in a range of from 0.3% by area to 1% by area) of inorganic antimicrobial microparticles after the plasma etching.

In some embodiments, the inorganic antimicrobial microparticles comprise the antimicrobial metal in an amount that is up to 50 wt. % (in some embodiments, up to 20 wt. %, up to 10 wt. %, up to 5 wt. %, or even up to 1 wt. %) of a total weight inorganic antimicrobial microparticles.

In some embodiments, the substrate surface comprises a low surface energy plastic.

In some embodiments, providing the plastic substrate having a substrate surface comprises at least one of injection molding, thermoforming, or extruding.

In some embodiments, the substrate surface comprises a high touch surface. In some embodiments, the substrate surface comprises any of a medical device or medical device component, a food preparation surface, or a doorknob.

In some embodiments of the method of the disclosure, the plasma etching comprises positioning the plastic substrate in a process chamber, introducing a process gas into the process chamber, and generating the plasma. In some other embodiments, the plasma etching comprises positioning the plastic substrate in a process chamber, introducing a process gas into a remote plasma generation chamber, generating the plasma remote from the process chamber, and introducing the plasma to the process chamber.

Methods of the current disclosure are useful for practical manufacture of plastic articles having an antimicrobial surface (e.g., medical devices, food preparation surfaces, high-touch surfaces). The manufacturing may be carried out in a continuous mode, suitable for production of multiple instances of plastic articles having an antimicrobial surface. The manufacturing may be carried out in a solventless mode, potentially minimizing environmental impact, and potentially reducing manufacturing costs.

The method of the current disclosure can uniquely provide advantages that include a one-time plasma treatment for generation of the antimicrobial surface (i.e., potentially avoiding higher cost associated with reapplication of an antimicrobial coating), avoiding the need for chemically bonding the antimicrobial agent to the substrate surface (chemical bonding of other antimicrobials to polymers may reduces their antimicrobial activity), and immobilization of the inorganic antimicrobial microparticles in the substrate surface (some other antimicrobial coatings are water soluble and are quickly washed away).

The term “antimicrobial” as used herein describes an agent that can reduce the pathogenic contamination of a surface.

The term “ceramic carrier” as used herein describes a ceramic material that serves as a carrier for an inorganic antimicrobial agent. The ceramic carrier may or may not have antimicrobial activity.

The term “high touch surface” as used herein describes a surface that is frequently touched by humans (e.g., touched by a human hand, optionally a gloved human hand).

The term “inorganic antimicrobial” as used herein describes an antimicrobial composition that is at least 95 wt. % inorganic materials.

The term “low surface energy” as used herein describes a substrate surface having a surface energy of less than about 30 dynes per square centimeter.

The term “microorganism,” “microbe,” or a derivative thereof, as used herein refers to any microscopic organism, including without limitations, one or more of bacteria, viruses, algae, fungi and protozoa. In some cases, the microorganisms of particular interest are those that are pathogenic, and the term “pathogen” is used herein to refer to any pathogenic microorganism.

The term “microparticles” as used herein describes particles between 0.1 micrometer and 100 micrometers in size.

The term ““plasma” as used herein describes a partially or fully ionized gas composed of ions, electrons, and neutral species. The plasma can be generated from various inert gases and reactive gases, as well as mixtures of inert gases, mixtures of reactive gases, and/or mixtures of inert gases and reactive gases.

The term “plasma etching” as used herein describes a process of subjecting a substrate to a plasma (or plasma products, in the case of a remote plasma etching), resulting in the removal of a portion of the substrate surface and thereby exposing material within the substrate.

The term “plastic” as used herein describes any of a wide range of synthetic or semi-synthetic organic solids used in the manufacture of industrial products.

The term “substrate” as used herein describes a non-porous sheet, a porous sheet, a fabric, a fiber, or a combination thereof.

### BRIEF DESCRIPTION OF THE DRAWINGS

FIGS. 1A-1B are profile representations of an exemplary plastic substrate of the current disclosure, before (FIG. 1A) and after (FIG. 1B) plasma etching the substrate surface;

FIG. 1C is an enlarged view of a portion of the substrate surface of FIG. 1B;

FIGS. 2A-2B are profile representations of an exemplary plastic substrate of the current disclosure, illustrating the interaction of microbes with the substrate surface, before (FIG. 2A) and after (FIG. 2B) plasma etching the substrate surface.

Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only unless otherwise noted.

### DETAILED DESCRIPTION

The present disclosure is directed to methods of processing plastic substrates comprising inorganic antimicrobial microparticles disposed within. The methods according to the disclosure involve providing a plastic article having a substrate surface, wherein the plastic article comprises inorganic antimicrobial microparticles disposed within, and plasma etching the substrate surface to expose a portion of the inorganic antimicrobial microparticles.

Antimicrobial agents can reduce pathogenic contamination of the substrate surface. Examples of suitable levels of antimicrobial activity include microbial load reductions of at least about 90% for at least one of S. aureus (gram positive) and Ps. aeruginosa (gram negative) pathogens, Examples of even more suitable levels of antimicrobial activity include microbial load reductions of at least about 99% for at least one of S. aureus (gram positive) and Ps. aeruginosa (gram negative) pathogens. Examples of particularly suitable levels of antimicrobial activity include microbial load reductions of at least about 90% for both of S. aureus (gram positive) and Ps. aeruginosa (gram negative) pathogens. Finally, examples of even more particularly suitable levels of antimicrobial activity include microbial load reductions of at least about 99% for both of S. aureus (gram positive) and Ps. aeruginosa (gram negative) pathogens. The “microbial load reductions” herein refer to microbial load reductions obtained pursuant to ASTM E2180-01.

The plastic substrate of the disclosure having a substrate surface, and comprising inorganic antimicrobial microparticles within, can be produced by a wide variety of known methods for making plastic articles from plastic compositions. Known techniques for forming plastic articles from plastic compositions include injection molding, thermoforming, and extruding. Alternatively, the plastic substrate of the current disclosure may include a plastic coating composition on a surface of an article. Whether the entire article is formed from the plastic composition, or the plastic composition is used as a coating composition, the inorganic antimicrobial microparticles are typically introduced into the plastic composition prior to forming the plastic article from the plastic composition. Methods and compositions for including inorganic antimicrobial compounds in plastic compositions for use in providing plastic substrates therefrom include those described in U.S. Published Patent Application 2007/082971 (Mocchia), and in U.S. Pat. Nos. 4,603,152 (Laurin et al.), 5,393,809 (Gueret), 5,137,957 (Asai, et al.), 5,698,229 (Ohsumi et al.), and in PCT Published Application WO0179349 (Mocchia).

Suitable plastic compositions for providing plastic substrates of the current disclosure include acrylonitrile butadiene styrenes, polyacrylonitriles, polyamides, polycarbonates, polyesters, polyetheretherketones, polyetherimides, polyethylenes such as high density polyethylenes and low density polyethylenes, polyethylene terephthalates, polylactic acids, polymethyl methyacrylates, polypropylenes, polystyrenes, polyurethanes, poly(vinyl chlorides), polyvinylidene chlorides, polyethers, polysulfones, silicones, and blends and copolymers thereof. In some embodiments, the substrate surface comprises a low energy plastic.

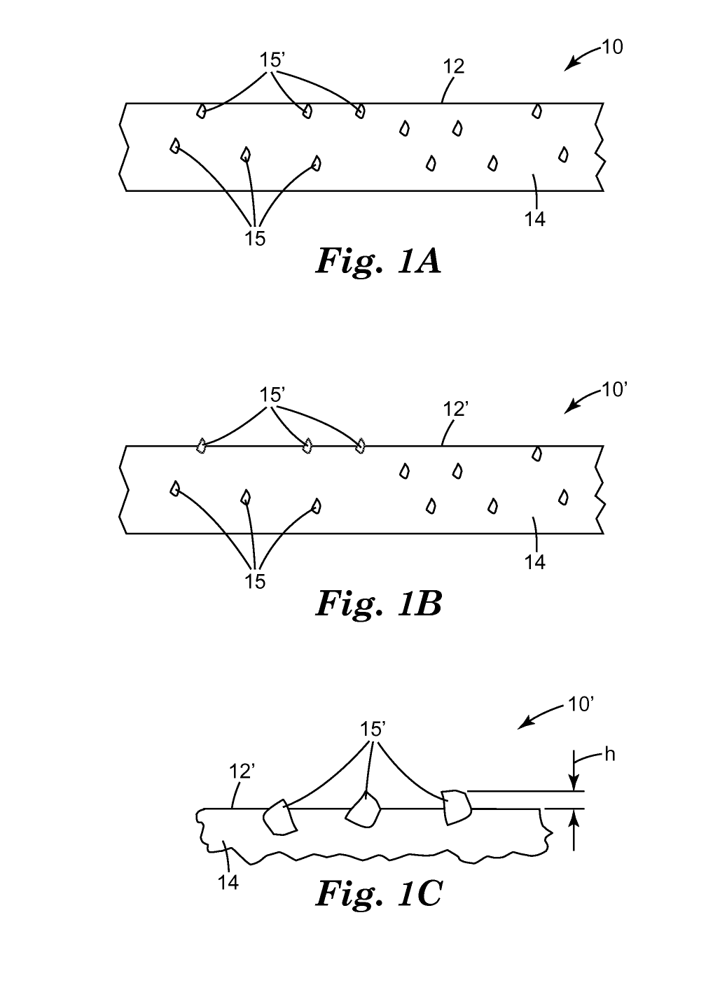

The plastic substrate of the exemplary method of the current disclosure has the inorganic antimicrobial microparticles within (i.e., disposed within). In FIG. 1A, plastic substrate 10 having substrate surface 12 and interior 14 has inorganic antimicrobial microparticles 15 and 15′ within (i.e., inorganic microparticles 15 and 15′ are within interior 14). In FIG. 1B, plastic article 10′ has etched surface 12′, resulting from plasma etching of plastic substrate 10, and including inorganic antimicrobial microparticles 15′ exposed on plasma etched surface 12′. FIG. 1C shows an enlarged portion of the etched surface 12′, including inorganic antimicrobial microparticles 15′ exposed by plasma etching. In organic antimicrobial microparticles 15′ are shown as protruding by a height “h”. Height “h” may vary, depending on selection of materials, size of the inorganic antimicrobial microparticles, and plasma etching conditions. In some embodiments, “h” is in a range of from 0.1 micrometers to 5 micrometers.

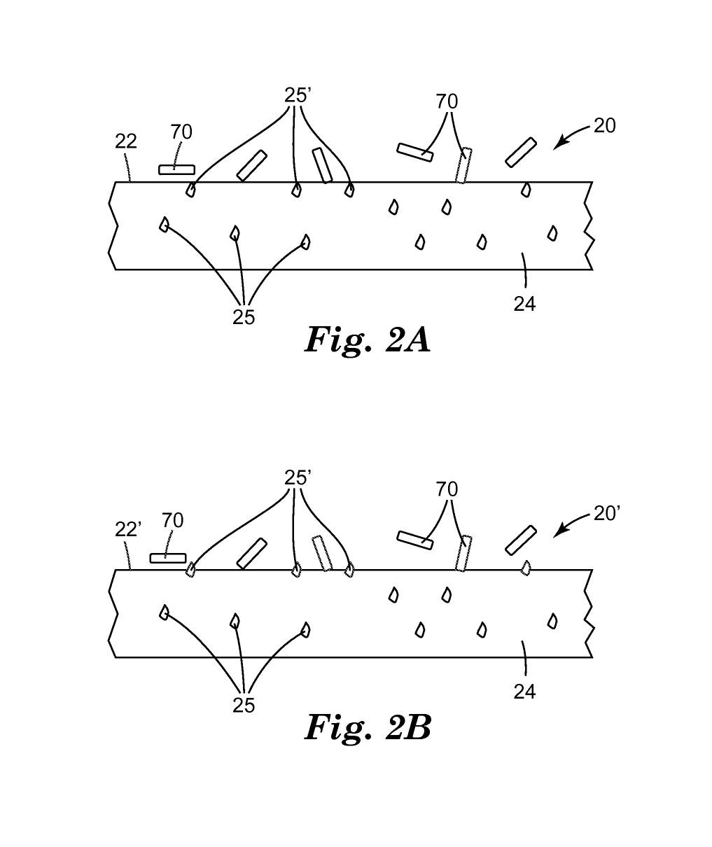

In FIG. 2A, plastic substrate 20 having substrate surface 22 and interior 24 has inorganic antimicrobial microparticles 25 and 25′ is shown, including pathogens 70 on or near substrate surface 22. In FIG. 2B, plastic article 20′ has etched surface 22′, resulting from plasma etching of plastic substrate 20, and having inorganic antimicrobial microparticles 25′ exposed on etched surface 22′, with pathogens 70 on or near inorganic antimicrobial microparticles 25′ in etched surface 22′. Without being bound by theory, it is believed that inorganic antimicrobial microparticles exposed by plasma etching of plastic substrate 10 (or 20) serve as a source of antimicrobial metal that kills pathogens on or near plastic articles having the antimicrobial surface of the current disclosure.

In some embodiments, the inorganic antimicrobial microparticles of the current disclosure include an inorganic carrier material and at least one antimicrobial metal. In some embodiments, the inorganic carrier material comprises at least one of a metal oxide (e.g., alumina, titania, zirconia), or a metal phosphate. In some embodiments, the inorganic carrier material comprises a ceramic carrier material. In some embodiments the ceramic carrier comprises at least one of clay, zeolite, or silicon dioxide. In some embodiments, the inorganic carrier material comprises a glass matrix.

Examples of suitable inorganic antimicrobial agents include transition metal ion-based compounds, (e.g., silver, zinc, copper, gold, tin and platinum-based compounds). In some embodiments, the inorganic antimicrobial microparticles comprises up to 50 wt. % (in some embodiments, up to 40 wt. %, up to 30 wt. %, up to 20 wt. %, or even up to 10 wt. %) of the antimicrobial metal.

In an exemplary embodiment, the antimicrobial metal is an ionic silver species. Silver is well known for imparting antimicrobial activity to a surface with minimal risk of developing bacterial resistance. Silver ions are broad spectrum antimicrobials that kill microorganisms without significant negative effects on human cells. In contrast to antibiotics, silver ions are rarely associated with microbial resistance. As such, the systematic use of silver-containing compounds generally does not generate concerns in the medical field over antibiotic-resistant bacteria.

Without being bound by theory, the antimicrobial activity of silver is believed to be due to free silver ions or radicals, where the silver ions kill microbes by blocking the cell respiration pathway (by attaching to the cell DNA and preventing replication) and by disruption of the cell membrane. Silver ions are also rarely associated with microbial resistance and do not exhibit significant negative effects on human cells. As such, systematic use of silver-containing compounds generally does not generate concerns in the medical field over antibiotic-resistant bacteria.

Examples of suitable silver-containing antimicrobial agents include silver sulfate, silver acetate, silver chloride, silver lactate, silver phosphate, silver stearate, silver thiocyanate, silver proteinate, silver carbonate, silver nitrate, silver sulfadiazine, silver alginate, silver nanoparticles, silver-substituted ceramic zeolites, silver complexed with calcium phosphates, silver-copper complexed with calcium phosphates, silver dihydrogen citrates, silver iodines, silver oxides, silver zirconium phosphates, silver-substituted glass, and combinations thereof.

Suitable commercially available silver-containing inorganic antimicrobial agents include silver zeolites (e.g., those available from AgION Technologies Inc., Wakefield, Mass. under the trade designation “AGION”), AgZn zeolites (e.g., those available from Ciba Specialty Chemicals, Tarrytown, N.Y., under the trade designations “IRGAGUARD B5 000” and “IRGAGUARD B8000”), silver sodium hydrogen zirconium phosphates (e.g., those available from Milliken Chemicals, Spartanburg, S.C., under the trade designation “ALPHASAN), and silver glass (e.g., the silver glass available from Giltech, Scotland, UK, under the trade designation “CORGLAES” Ag, and the silver glass available from Polygiene AB, Malmo, Sweden, under the trade designation “POLYGENE 008”). A suitable water soluble glass composition that includes silver oxide includes, for example, the glass fibers or glass wool described in U.S. Pat. No. 6,528,443 (Healy).

In some embodiments, the inorganic antimicrobial particles may contain copper as the antimicrobial metal, including ionic copper species (e.g., the copper glass available from Giltech, Scotland, UK, under the trade designation “CORGLAES” Cu).

In some embodiments, the inorganic antimicrobial microparticles have an average particle size that is greater than 1 micrometer (in some embodiments, greater than 2 micrometers, greater than 5 micrometers, or even greater than 10 micrometers). In some embodiments, the inorganic antimicrobial microparticles have an average particle size in a range from 5 micrometers to 10 micrometers.

Plasmas for use in accordance with the present methods can be generated by various known methods, such as by the application of electric and/or magnetic fields. Various types of power sources can be used to generate suitable plasmas for use in the disclosed methods; typical power sources include direct current (DC), radiofrequency (RF), microwave, and laser power sources. A parallel-plate plasma source, for example, uses a RF power source to generate plasma through gas discharge. Another example of a RF power source is an inductive coupling plasma source which uses an inductively coupled RF source to generate plasma. The RF power source can operate at 13.56 MHz or at another frequency. Microwave power sources include, for example, the electron cyclotron resonance (ECR) source. The microwave frequency can be 2.45 GHz or another frequency.

In accordance with the present disclosure, plasmas can be generated at various pressures, and suitable plasma pressures can be readily determined by one of ordinary skill. Plasma can be generated, for example, at atmospheric pressure or under vacuum. Damage to the plastic article can be more prevalent at higher pressures compared to lower pressures. Thus, the use of lower pressures can prevent or reduce damage to the plastic article, thereby allowing increased exposure times and/or increased power levels to be used. Typical pressures at which plasma can be generated include pressures of about 0.001 Torr to about 760 Torr, for example, about 0.01 Torr to about 100 Torr, about 0.05 Torr to about 50 Torr, and/or about 0.1 Torr to about 10 Torr, but higher and lower pressures also can be used.

The substrate surface can be exposed to the plasma for various periods of time. The length of desired exposure can be readily determined by one of ordinary skill. Further, the length of exposure can vary depending on the reactivity of the plasma and/or the desired properties of the processed substrate surface. Damage to the plastic article can be more prevalent after longer exposure times compared to shorter exposure times. Thus, the use of shorter exposure times can prevent or reduce damage to the plastic article thereby allowing increased pressure and/or increased power levels to be used. Typically, the substrate surface is exposed for about 1 second to about 2 hours, but shorter and longer exposure periods can be used. Generally, the substrate surface is exposed to the plasma for about 5 seconds to about 1 hour, about 5 seconds to about 10 minutes, about 10 seconds to about 5 minutes, or even about 10 seconds to about 3 minutes.

In some embodiments, the substrate surfaces can be exposed to the plasma for a continuous period of time. In some other embodiments, the substrate surfaces can be exposed to the plasma for intermittent, or “pulsed”, periods of time, wherein “pulsing” can comprise exposure of the substrate surface to the plasma for a period of time, followed by a period during which the substrate surface is not exposed to the plasma. Such periods of exposure and non-exposure can be repeated multiple times. Damage to the substrate or substrate coating can be more prevalent after continuous exposure processes compared to pulsed exposure processes. Thus, the use of pulsed exposure processes can prevent or reduce damage to the plastic article, thereby allowing increased pressure and/or increased power levels to be used. Increased power levels over pulsed periods may advantageously reduce the amount of time in which the substrates are exposed to the plasma, thereby reducing part cycle time and increasing manufacturing efficiencies.

In accordance with the methods of the present disclosure, plastic article substrate surfaces can be exposed to plasma in a suitable process chamber. Exposing the substrate surfaces in a process chamber includes positioning the substrate surface in a process chamber, introducing a process gas into the process chamber, and generating the plasma. Generally, about 0.05 watts to about 30,000 watts of power can be used to generate the plasma, but higher and lower powers also can be used. Typical power ranges can be from about 0.1 watts to about 10,000 watts, from 0.5 watts to about 5,000 watts, from about 1 watt to about 1,000 watts, from about 2 watts to about 500 watts, from about 5 watts to about 250 watts, and/or from about 10 watts to about 100 watts. The plasma can be generated in the process chamber from a suitable process gas. The process gas includes inert gases, such as helium, neon, argon, krypton, and xenon. Other suitable process gases include reactive gases, such as air, oxygen, hydrogen peroxide, nitrogen, hydrogen chloride, hydrogen bromide, fluorine, chlorine, bromine, iodine, halogenated hydrocarbons, nitrogen trifluoride, sulfur hexafluoride, and ammonia. Mixtures of gases, including mixtures of inert gases and reactive gases, also are contemplated for use in the inventive methods.

Thus, suitable plasmas include, but are not limited to: helium plasmas, neon plasmas, argon plasmas, krypton plasmas, xenon plasmas, air plasmas, oxygen plasmas, hydrogen peroxide plasmas, nitrogen plasmas, ammonia plasmas, and halogen plasmas. Exemplary halogen plasmas include hydrogen chloride plasmas, hydrogen bromide plasmas, fluorine plasmas, chlorine plasmas, bromine plasmas, iodine plasmas, and plasmas of halogenated hydrocarbons, nitrogen trifluoride, sulfur hexafluoride, as well as mixtures of the foregoing plasmas. An exemplary plasma mixture is a plasma of hydrogen peroxide and air.

Remote plasma treatment may be employed in special situations where the substrate for treatment is damaged by the electron, ion and photon fluxes from the plasma. By moving the plasma zone away from the substrates, the electron, ion and photon induced damage is minimized and only the reactive free radical products from the plasma are transported to the process chamber where the substrates are located.

The etching is carried out in a manner whereby the organic component is preferentially etched, exposing the inorganic particles. The etching time is carefully adjusted so that the inorganic particles are only partially exposed. The unexposed portion of the inorganic particles which are buried in the organic matrix underneath provide anchoring for the particles, thereby preventing them from being blown away.

### EMBODIMENTS

Item 1. A method of making a plastic article having an antimicrobial surface, the method comprising:

providing a plastic substrate having a substrate surface, wherein the plastic substrate comprises inorganic antimicrobial microparticles disposed within; and

plasma etching the substrate surface to expose a portion of the inorganic antimicrobial microparticles.

Item 2. The method of item 1, wherein the inorganic antimicrobial microparticles comprise a ceramic carrier and at least one antimicrobial metal.
Item 3. The method of item 2, wherein the ceramic carrier is at least one of clay, zeolite, or silicon dioxide.
Item 4. The method of item 2, wherein the at least one antimicrobial metal is a transition metal.
Item 5. The method of item 4 wherein the at least one antimicrobial metal is selected from the group consisting of silver, gold, copper, and zinc.
Item 6. The method of any preceding item, wherein the inorganic antimicrobial microparticles have an average particle size that is at least 1 micrometer.
Item 7. The method of any preceding item, wherein the inorganic antimicrobial microparticles have an average particle size that is in a range of from 5 micrometers to 10 micrometers.
Item 8. The method of any preceding item, wherein the inorganic antimicrobial microparticles have an average particle size that is at least an order of magnitude smaller than a smallest dimension of the plastic article.
Item 9. The method of any preceding item, wherein the inorganic antimicrobial microparticles are stable to processing at temperatures up to 1000° C.
Item 10. The method of any preceding item, wherein the substrate surface comprises at least 0.1% by area of inorganic antimicrobial microparticles after the plasma etching.
Item 11. The method of any of items 2 to 10, wherein the inorganic antimicrobial microparticles comprise the antimicrobial metal in an amount that is less than 50 wt. % of a total weight inorganic antimicrobial microparticles.
Item 12. The method of any preceding item, wherein the substrate surface comprises a low surface energy plastic.
Item 13. The method of any preceding item, wherein providing the article having a substrate surface comprises at least one of injection molding, thermoforming, or extruding.
Item 14. The method of any preceding item, wherein the substrate surface comprises a high touch surface.
Item 15. The method of any one of items 1 to 13, wherein the substrate surface comprises a medical device or medical device component.
Item 16. The method of any one of items 1 to 13, wherein the substrate surface comprises a food preparation surface.
Item 17. The method of any one of items 1 to 13, wherein the substrate surface comprises a doorknob.
Item 18. The method of any one of items 1 to 13, wherein the plasma etching comprises positioning the plastic substrate in a process chamber, introducing a process gas into the process chamber, and generating the plasma.
Item 19. The method of any one of items 1 to 13, wherein the plasma etching comprises positioning the plastic substrate in a process chamber, introducing a process gas into a remote plasma generation chamber, generating the plasma remote from the process chamber, and introducing the products of the plasma into the process chamber.

### Examples

### Plasma Etching Conditions

Plasma etching was performed by using two different plasma treatment systems, a batch plasma system, and a roll-to-roll plasma treatment system. The two different plasma systems and the plasma etching procedure are described below.

### Plasma Treatment—Batch Method (for Conditions C1-C3)

A commercial batch plasma system (Plasmatherm Model 3032) configured for reactive ion etching (RIE) with a 27-inch lower powered electrode and central gas pumping. The chamber is pumped by a roots blower (Edwards Model EH1200) backed by a dry mechanical pump (Edwards Model iQDP80). RF power is delivered by a 5 kW, 13.56 Mhz solid-state generator (RFPP Model RF50S0 through an impedance matching network. The system has a nominal base pressure of 5 mTorr. The flow rates of the gases are controlled by MKS flow controllers.

Samples of the substrates were placed on the powered electrode of the batch plasma apparatus. Typically, samples were taped down around the perimeter, using an adhesive tape, in order to expose only one major surface of the samples to plasma treatment. The plasma treatment was done by feeding the appropriate types of gases at the prescribed flow rates. Once the flows were stabilized, the RF power was applied to the electrode to generate the plasma. The plasma was left on for a prescribed amount of time as detailed in Table 1. After the plasma treatment was completed, the gases were shut off and the chamber was vented to atmosphere and the substrates were taken out of the chamber.

### Plasma Treatment—Roll-to-Roll Method (for Condition C4)

The treatment was performed in an apparatus described in U.S. Pat. No. 5,948,166 (David et al.) except that the drum width was increased to 42.5 inches. The roll of film was loaded into the plasma apparatus and indexed to a suitable location, gases enabled at the prescribed flow rates and RF power enabled to the drum electrode at the prescribed power of 5000 watts and etching carried out for the indicated time period.

Parameters for the four different plasma etching conditions C1-C4 are summarized in Table 1.

TABLE 1

| | | | | Etching |
|---|---|---|---|---|
| Plasma Etching | | | | Time, |
| Condition | Plasma gas | Pressure | Power, Watts | seconds |
| C1 | O₂: 500 sccm | 45 mTorr | 1000 | 360 |
| C2 | O₂: 500 sccm | 60 mTorr | 1000 | 360 |
| | C₃F₈: 100 sccm | | | |
| C3 | O₂: 500 sccm | 45 mTorr | 1000 | 160 |
| C4 | O₂: 400 sccm | 9 mTorr | 5000 | 120 |

### Test Methods

“Zone of Inhibition” antimicrobial testing of samples was carried out using the following disk diffusion (“Kirby-Bauer”) method. The method uses antimicrobial-impregnated material to test whether particular bacteria are susceptible to the antimicrobial agent. A known quantity of bacteria is plated onto agar plates in the presence of material with antimicrobial properties, and incubated for growth. If the bacteria are susceptible to a particular antimicrobial material, an area of clearing surrounds the sample (a zone of inhibition).

Staphylococcus aureus (ATCC 6538) was uniformly swabbed onto an agar plate (obtained from Teknova, Holister, Calif., under the trade designation “MUELLER HINTON II AGAR PLATE”), to give a seeded agar plate surface. From a test film, a sample disc (8 millimeters in diameter) was cut out and placed in the center of the seeded agar plate surface, with the plasma-etched substrate surface against the seeded agar plate surface. The agar plate with seeded agar plate surface and test film sample was then incubated for 24 hours at 37° C. to allow for growth of a bacterial lawn, and by which time samples released antimicrobial agent had a zone of inhibition evident as a clear zone around the film sample disc. The diameter of the zone of inhibition was measured as the diameter of the clear zone including the sample disc. Control samples (i.e., not plasma-etched) were also tested, using a control sample disc, 8 millimeters in diameter.

“Plastic Surface Antimicrobial Activity” was tested according to ASTM E2180-01, with the following details. A molten (45° C.) agar slurry was inoculated with a culture of bacterial cells, using either Staphylococcus aureus (ATCC 6538) or Enterococcus faecium (ATCC 49322) to inoculate the agar slurry. A thin layer of the inoculated agar slurry (0.25 milliliter) was distributed onto the plasma-etched sample films and non-etched control films, and the films were then incubated for desired time at 28° C.±1° C. The microorganisms were recovered from the surface of the films and neutralized using Dey/Engley (D/E) Neutralizing Broth. Bacterial plate counts were performed using culture plates (obtained from 3M Company, St. Paul, Minn., under the trade designation “3M PETRIFILM AEROBIC COUNT (AC) PLATES”) according to the manufacturer's instructions. The colony counts were recorded as colony-forming unit (CFU) per cm². The difference between bacterial count recovered from the surface when the inoculum is immediately applied to the surface (T=0 hr) and the bacterial count in the slurry after 24 hours of contact with the antimicrobial surface represents the log reduction. The plasma-etched films were compared to control non-etched films having the inorganic antimicrobial microparticles within (“no etching”), and controls having non-etched film lacking the inorganic antimicrobial microparticles (“plain, no etching”).

MATERIALS

| | |
|---|---|
| Silver | An inorganic antimicrobial microparticle composite of silver, |
| glass | calcium, and phosphate, having a microparticle size of 5 to 8 |
| | micrometers, 10 wt. % in polypropylene pellets, obtained from |
| | Polygiene AB, Malmö, Sweden, under the trade designation |
| | “POLYGIENE 108” |
| Silver | A silver zeolite inorganic antimicrobial microparticle, having |
| zeolite | a microparticle size of 10 micrometers, obtained as a white |
| | hygroscopic powder from AgION Technologies, Wakefield, |
| | MA, under the trade designation “AGION” |
| PP | Polypropylene, obtained from Exxon Chemical Co., Houston, |
| | TX, under the trade designation “POLYPROPYLENE 1024” |

### Preparation of Polypropylene Film (PPF)

PP without any inorganic antimicrobial microparticles was also pressed into film. Film thickness was not important since only the surface was to be plasma treated and tested.

### Preparative Example 1 (PE1)

Silver glass was diluted to 1% in polypropylene by adding 45 grams of PP to 5 grams of the 10% Silver glass/polypropylene pellet master batch. This 50 gram mixture was compounded in a Brabender mixer at 400° C. and then pressed into film using a Wabash Platen press (175-190° C. at 1-10 ton). Two polypropylene films were pressed, each containing 1 wt. % silver glass.

### Preparative Example 2 (PE2)

Silver zeolite (0.5 gram) was added to 49.5 grams of PP. This 50 gram mixture was also compounded in a Brabender mixer at 400° C. and then pressed into film using a Wabash Platen press (175-190° C. at 1-10 ton). Two polypropylene films were pressed, each containing 1 wt. % silver zeolite.

### Control Example 1

### Plasma Etched PP (CE1)

A sample of the PPF was cut to about 10 centimeters by 10 centimeters, and the sample was subjected to plasma etching according to condition C1 in Table 1.

### Control Example 2

### Plasma Etched PP (CE2)

A sample of the PPF was cut to about 10 centimeters by 10 centimeters, and the sample was subjected to plasma etching according to condition C2 in Table 1.

### Examples 1-4

For each of Examples 1-4, a sample of the film from PE1 (1 wt. % silver glass) was cut to about 10 centimeters by 10 centimeters, and each sample was subjected to plasma etching according to the conditions indicated in Table 2.

### Examples 5-8

For each of Examples 5-8, a sample of the film from PE2 (1 wt. % silver zeolite) was cut to about 10 centimeters by 10 centimeters, and each sample was subjected to plasma etching according to the conditions indicated in Table 2.

“Zone of inhibition” test results are also provided in Table 2 for each of the samples listed, after plasma etching (where plasma etching is indicated). The diameter of the zone of inhibition for each of the samples was observed to be the same as the diameter of the test sample (i.e., 8 millimeters).

TABLE 2

| | | | Zone of |
|---|---|---|---|
| | Plasma Etching | | Inhibition, |
| Sample | Conditions | Sample description | millimeters |
| PPF | NONE | Polypropylene 1024 (plain) | 8 |
| PE1 | NONE | 1 wt. % Silver Glass | 8 |
| PE2 | NONE | 1 wt. % Silver Zeolite | 8 |
| CE1 | C1 | Polypropylene 1024 (plain) | 8 |
| Ex. 1 | C1 | 1 wt. % Silver Glass | 8 |
| Ex. 2 | C1 | 1 wt. % Silver Glass | 8 |
| Ex. 3 | C2 | 1 wt. % Silver Glass | 8 |
| Ex. 4 | C2 | 1 wt. % Silver Glass | 8 |
| Ex. 5 | C3 | 1 wt. % Silver Zeolite | 8 |
| Ex. 6 | C3 | 1 wt. % Silver Zeolite | 8 |
| Ex. 7 | C4 | 1 wt. % Silver Zeolite | 8 |
| Ex. 8 | C4 | 1 wt. % Silver Zeolite | 8 |

Plastic Surface Antimicrobial Activity test was performed on the plasma etched films of Examples 1-4 and related controls using Staphylococcus aureus as the inoculation organism, and the results are reported as the average of duplicate testing in Table 3.

TABLE 3

| | | Plasma | | | | |
|---|---|---|---|---|---|---|
| | | etching | Growth | Log | Log | Percent |
| | Sample | condi- | time, | (CFU/ | reduc- | reduc- |
| Sample | description | tions | hours | cm²) | tion | tion |
| PPF | Polypropylene | NONE | 0 | 5.2 | — | — |
| | 1024 (plain) | | | | | |
| PPF | Polypropylene | NONE | 24 | 5.2 | — | — |
| | 1024 (plain) | | | | | |
| PE1 | 1 wt. % silver | NONE | 24 | 5.1 | 0.04 | 8 |
| | glass | | | | | |
| Ex. 1 | 1 wt. % silver | C1 | 24 | 4.8 | 0.35 | 56 |
| | glass | | | | | |
| Ex. 2 | 1 wt. % silver | C2 | 24 | 4.0 | 1.12 | 92 |
| | glass | | | | | |
| Ex. 3 | 1 wt. % silver | C3 | 24 | 4.2 | 0.90 | 88 |
| | glass | | | | | |
| Ex. 4 | 1 wt. % silver | C4 | 24 | 4.2 | 0.93 | 88 |
| | glass | | | | | |

Plastic Surface Antimicrobial Activity test was performed on the plasma etched films of Examples 5-8 and related controls using Staphylococcus aureus as the inoculation organism, and the results are reported as the average of duplicate testing in Table 4.

TABLE 4

| | | Plasma | | | | |
|---|---|---|---|---|---|---|
| | | etching | Growth | Log | Log | Percent |
| | Sample | condi- | time, | (CFU/ | reduc- | reduc- |
| Sample | description | tions | hours | cm²) | tion | tion |
| PPF | Polypropylene | NONE | 0 | 5.6 | — | — |
| | 1024 (plain) | | | | | |
| PPF | Polypropylene | NONE | 24 | 5.4 | — | — |
| | 1024 (plain) | | | | | |
| PE2 | 1 wt. % silver | NONE | 24 | 4.7 | 0.7 | 79.2 |
| | zeolite | | | | | |
| Ex. 5 | 1 wt. % silver | C1 | 24 | 2.9 | 2.5 | 99.7 |
| | zeolite | | | | | |
| Ex. 6 | 1 wt. % silver | C2 | 24 | 3.2 | 2.1 | 99.3 |
| | zeolite | | | | | |
| Ex. 7 | 1 wt. % silver | C3 | 24 | 3.9 | 1.5 | 96.5 |
| | zeolite | | | | | |
| Ex. 8 | 1 wt. % silver | C4 | 24 | 2.9 | 2.5 | 99.7 |
| | zeolite | | | | | |
| CE1 | Polypropylene | C1 | 0 | 5.4 | — | — |
| | 1024 (plain) | | | | | |

Plastic Surface Antimicrobial Activity test was performed on the plasma etched films of Example 2, Example 6, and related controls using Enterococcus faecium as the inoculation organism, and the results are reported as the average of duplicate testing in Table 5.

TABLE 5

| | | Plasma | | | | |
|---|---|---|---|---|---|---|
| | | etching | Growth | Log | Log | Percent |
| | Sample | condi- | time, | (CFU/ | reduc- | reduc- |
| Sample | description | tions | hours | cm²) | tion | tion |
| CE3 | Polypropylene | C2 | 0 | 5.6 | — | — |
| | 1024 (plain) | | | | | |
| CE3 | Polypropylene | C2 | 24 | 5.5 | — | — |
| | 1024 (plain) | | | | | |
| PE1 | 1 wt. % silver | NONE | 24 | 5.4 | 0.1 | 25 |
| | glass | | | | | |
| Ex. 2 | 1 wt. % silver | C2 | 24 | 3.6 | 1.9 | 99 |
| | glass | | | | | |
| PE2 | 1 wt. % silver | NONE | 24 | 5.0 | 0.5 | 69 |
| | zeolite | | | | | |
| Ex. 6 | 1 wt. % silver | C2 | 24 | 3.4 | 2.1 | 99 |
| | zeolite | | | | | |

The tests and test results described above are intended solely to be illustrative, rather than predictive, and variations in the testing procedure can be expected to yield different results. All quantitative values in the Examples section are understood to be approximate in view of the commonly known tolerances involved in the procedures used. The foregoing detailed description and examples have been given for clarity of understanding only. No unnecessary limitations are to be understood therefrom.

1. A method of making a plastic article having an antimicrobial surface, the method comprising:
providing a plastic substrate having a substrate surface, wherein the plastic substrate comprises inorganic antimicrobial microparticles disposed within; and
plasma etching the substrate surface to expose a portion of the inorganic antimicrobial microparticles.

2. The method of claim 1, wherein the inorganic antimicrobial microparticles comprise a ceramic carrier and at least one antimicrobial metal.

3. The method of claim 2, wherein the ceramic carrier is at least one of clay, zeolite, or silicon dioxide.

4. The method of claim 2, wherein the at least one antimicrobial metal is a transition metal.

5. The method of claim 4 wherein the at least one antimicrobial metal is selected from the group consisting of silver, gold, copper, and zinc.

6. The method of claim 1, wherein the inorganic antimicrobial microparticles have an average particle size that is at least 1 micrometer.

7. The method of claim 1, wherein the inorganic antimicrobial microparticles have an average particle size that is in a range of from 5 micrometers to 10 micrometers.

8. The method of claim 1, wherein the inorganic antimicrobial microparticles have an average particle size that is at least an order of magnitude smaller than a smallest dimension of the plastic article.

9. The method of claim 1, wherein the inorganic antimicrobial microparticles are stable to processing at temperatures up to 1000° C.

10. The method of claim 1, wherein the substrate surface comprises at least 0.1% by area of inorganic antimicrobial microparticles after the plasma etching.

11. The method of claim 2, wherein the inorganic antimicrobial microparticles comprise the antimicrobial metal in an amount that is less than 50 wt. % of a total weight inorganic antimicrobial microparticles.

12. The method of claim 1, wherein the substrate surface comprises a low surface energy plastic.

13. The method of claim 1, wherein providing the article having a substrate surface comprises at least one of injection molding, thermoforming, or extruding.

14. The method of claim 1, wherein the substrate surface comprises a high touch surface.

15. The method of claim 1, wherein the substrate surface comprises a medical device or medical device component.

16. The method of claim 1, wherein the substrate surface comprises a food preparation surface.

17. The method of claim 1, wherein the substrate surface comprises a doorknob.

18. The method of claim 1, wherein the plasma etching comprises positioning the plastic substrate in a process chamber, introducing a process gas into the process chamber, and generating the plasma.

19. The method of claim 1, wherein the plasma etching comprises positioning the plastic substrate in a process chamber, introducing a process gas into a remote plasma generation chamber, generating the plasma remote from the process chamber, and introducing the products of the plasma into the process chamber.
